(19) United States
(12) Patent Application Publication
(10) Pub. No.: US 2026/0192410 A1
(43) Pub. Date: Jul. 9, 2026

(54) MACHINE TOOL CONTROL DEVICE

(71) Applicant: FANUC CORPORATION, Yamanashi (JP)

(72) Inventor: Masashi YASUDA, Yamanashi (JP)

(73) Assignee: FANUC CORPORATION, Yamanashi (JP)

(21) Appl. No.: 19/131,528

(22) PCT Filed: Nov. 30, 2022
(86) PCT No.: PCT/JP2022/044222

§ 371 Date: May 20, 2025

(51) Int. Cl. B23Q 15/013; B23Q 15/08

(52) U.S. Cl. CPC B23Q 15/013; B23Q 15/08

(57) ABSTRACT

Provided is a machine tool control device for controlling threading, the device being capable of automatically setting the threading amount for achieving threading as desired by an operator, A machine tool control device 1 is provided with: a machining condition acquisition unit 11 that acquires machining conditions for threading; a machining determination unit 12 that determines the type of machining from the machining conditions; a threading amount rule setting unit 13 that, on the basis of a determination result from the machining determination unit 12, determines setting rules, which is a method for setting the threading amount of threading; and a threading amount determination unit 20 that determines the threading amount for machining on the basis of the machining conditions and the setting rules.

### TECHNICAL FIELD

The present disclosure relates to a control device for a machine tool.

### BACKGROUND ART

Conventionally, in a machine tool, to avoid such a situation that cutting chips continuously generated during machining are caught on a workpiece or a cutting tool to become a cause of abnormal cutting or a machine failure, for example, oscillation cutting in which a tool and a workpiece are oscillated relative to each other has been performed (for example, see Patent Document 1).

In oscillation cutting of this type, a tool route representing a path of a tool is set to partially overlap with a previous tool route to allow a non-contact motion, which is called air-cutting where the tool separates from a surface of a workpiece, to thereby shred cutting chips.

### CITATION LIST

### Patent Document

Patent Document 1: Japanese Unexamined Patent Application, Publication No. 2020-66169

### DISCLOSURE OF THE INVENTION

### Problems to be Solved by the Invention

Incidentally, in oscillation thread cutting, an operator often specifies a threading amount (a position on an X axis) similar or identical to that in normal thread cutting where no oscillation is performed. However, there has been a case where a value of the specified threading amount is not appropriate for actual oscillation thread cutting.

For example, compared with thread cutting where no oscillation is performed, thread cutting where oscillation is performed results in an increase in the number of machining operations leading to an increase in cycle time due to the machining principle of oscillation. Furthermore, although, in oscillation thread cutting where it is possible to cool machining heat on a cutting tool during air-cutting, there has been a possibility that cycle time can be shortened as an amount of cutting is increased per one machining, it has not been possible to utilize such a measure. Otherwise, in oscillation thread cutting, there may be a preferable case where, to mitigate a burden on a cutting tool, a threading amount is reduced to reduce an amount of cutting, compared with normal thread cutting where no oscillation is performed.

In view of the situations described above, an object of the present disclosure is to provide a technique for automatically setting a threading amount for achieving thread cutting as desired by an operator in a control device for a machine tool, which controls thread cutting.

### Means for Solving the Problems

The present disclosure is a control device for a machine tool that performs thread cutting on a workpiece using a cutting tool, the control device for the machine tool including: a machining condition acquisition unit that acquires machining conditions for thread cutting; a machining determination unit that determines a type of machining from the machining conditions; a threading amount rule setting unit that, based on a result of the determination by the machining determination unit, determines a setting rule that is a method for setting a threading amount for the thread cutting; and a threading amount determination unit that, based on the machining conditions and the setting rule, determines a threading amount used during machining.

### Effects of the Invention

According to the present disclosure, it is possible to provide a technique for automatically setting a threading amount for achieving thread cutting as desired by an operator in a control device for a machine tool, which controls thread cutting.

### BRIEF DESCRIPTION OF THE DRAWINGS

FIG. 1 is a functional block diagram of a control device for a machine tool, according to a first embodiment of the present invention;

FIG. 2 is a view illustrating an example of a machining program when no oscillation cutting is performed, in the first embodiment;

FIG. 3 is a graph illustrating a positional relationship between a workpiece and a cutting tool when no oscillation cutting is performed, in the first embodiment;

FIG. 4 is a view illustrating an example of a machining program when oscillation cutting is performed, in the first embodiment;

FIG. 5 is a graph illustrating a positional relationship between the workpiece and the cutting tool when a first setting rule is applied and a threading amount is changed;

FIG. 6 is a graph illustrating a positional relationship between the workpiece and the cutting tool during oscillation cutting when the first setting rule is applied;

FIG. 7 is a graph illustrating a positional relationship between the workpiece and the cutting tool when a second setting rule is applied and a threading amount is changed;

FIG. 8 is a graph illustrating a positional relationship between the workpiece and the cutting tool during oscillation cutting when the second setting rule is applied;

FIG. 9 is a flowchart illustrating an example of processing for generating a threading command by the control device for the machine tool;

FIG. 10 is a graph illustrating a positional relationship between the workpiece and the cutting tool when a setting rule is applied and a threading amount is set, in a second embodiment;

FIG. 11 is a functional block diagram of a control device for a machine tool, according to a third embodiment; and

FIG. 12 is a functional block diagram of a control device for a machine tool, according to a fourth embodiment.

### PREFERRED MODE FOR CARRYING OUT THE INVENTION

Embodiments of the present disclosure will now be described herein in detail with reference to the accompanying drawings. Note that, in the below descriptions for a second embodiment and later embodiments, like reference numerals designate identical or corresponding configurations to those in a first embodiment, and their descriptions are thus appropriately omitted.

### First Embodiment

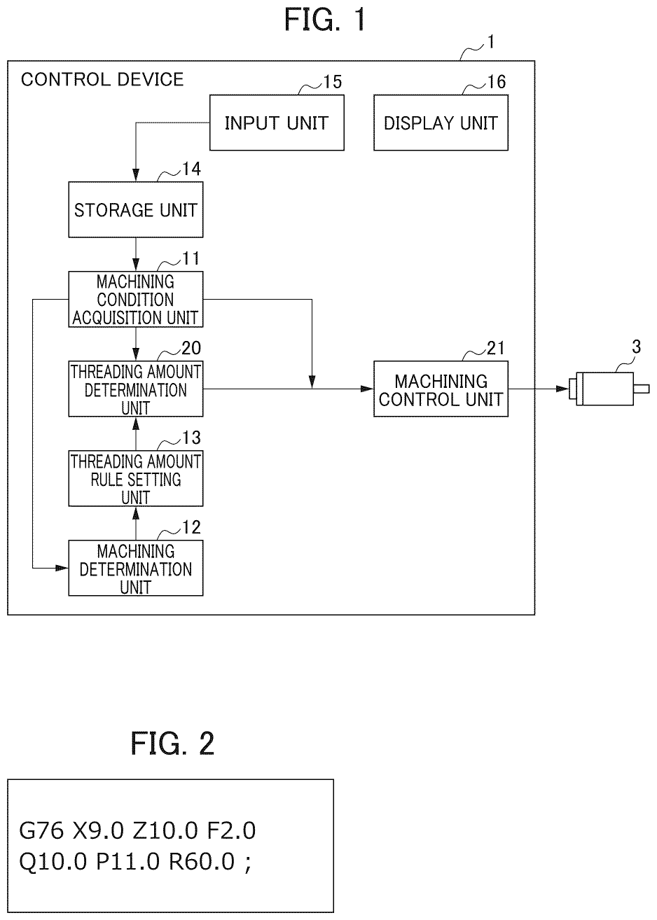

FIG. 1 is a functional block diagram of a control device 1 for a machine tool, according to the first embodiment of the present invention. The control device 1 for the machine tool, illustrated in FIG. 1, is one for executing thread cutting using a cutting tool that oscillates in diameter directions with respect to a workpiece. Note that FIG. 1 illustrates, for the purpose of convenience, only a motor 3 that drives one feed shaft. Furthermore, in cutting machining according to the present embodiment, workpieces are not limited in shape. That is, applicable cases also include a case where a workpiece has a tapered portion or an arc portion on its machining surface and a plurality of feed shafts (on a Z axis and an X axis) are required and a case where a workpiece has a circular column shape or a cylindrical shape and a specific one feed shaft (on the Z axis) is required.

The control device 1 for the machine tool, according to the present embodiment, includes, for example, a computer including a memory including a read only memory (ROM) and a random access memory (RAM), a central processing unit (CPU), and a communication controller, which are coupled to each other via a bus. A function and operation of each functional unit described later are achieved as the CPU and the memory installed in the computer described above and control programs stored in the memory cooperate with each other. Furthermore, the control device 1 for the machine tool may include, for example, a computer numerical controller (CNC) or a programmable logic controller (PLC) or may be coupled to a higher computer that outputs machining conditions including a rotation speed, in addition to a machining program.

As illustrated in FIG. 1, the control device 1 for the machine tool includes a machining condition acquisition unit 11, a machining determination unit 12, a threading amount rule setting unit 13, a threading amount determination unit 20, a machining control unit 21, a storage unit 14, an input unit 15, and a display unit 16.

The machining condition acquisition unit 11 acquires machining conditions and oscillation conditions for allowing a workpiece to undergo oscillation cutting. As machining conditions and oscillation conditions that the machining condition acquisition unit 11 acquires, for example, those stored in the storage unit 14 or those outputted from an external computer may be utilized.

Example machining conditions include information related to a thread shape and cutting conditions with respect to a workpiece. Example information related to a thread shape includes a thread lead (mm), a thread diameter (mm), and a thread ridge angle (°). Example cutting conditions with respect to a workpiece include a rotation number S (1/min) of a main shaft, a finishing allowance (mm), a number of times of finishing machining (number of times), and a threading position (mm). Example threading positions include, but are not particularly limited to, reference positions such as a position of one end (for example, a position of a lower end) and a position of another end (a position of an upper end) in oscillation directions. In addition, a threading position may be information with which it is possible to identify a threading position, including, for example, an area of cutting. As described above, a threading amount may be a length, an area, or information identifying a position.

Furthermore, example oscillation conditions include information related to a number of oscillations in the diameter directions of a workpiece and information related to an oscillation amplitude in the diameter directions of the workpiece. One example of the information related to a number of oscillations in the diameter directions of the workpiece is an oscillation frequency multiplying factor I (multiplication) indicating an oscillation frequency per one rotation of the main shaft. Furthermore, one example of the information related to an oscillation amplitude in the diameter directions of the workpiece, which is relative between the cutting tool and the workpiece, is an oscillation amplitude multiplying factor K (multiplication) indicating a magnitude of an oscillation amplitude with respect to a threading amount in the diameter directions of the workpiece undergoing thread cutting.

The machining determination unit 12 determines a type of machining to be executed based on the machining conditions that the machining condition acquisition unit 11 acquires. The machining determination unit 12 according to the first embodiment determines whether machining to be executed based on the machining conditions is oscillation thread cutting or non-oscillation thread cutting.

The threading amount rule setting unit 13 sets a setting rule for determining a threading amount based on a result of the determination by the machining determination unit 12, Setting rules are, for example, set beforehand to each correspond to a type of machining that the machining determination unit 12 determines. The setting rules may be stored in the storage unit 14 or may be outputted from an external computer.

With a setting rule in the first embodiment, although a specified set threading amount is not changed in a case of normal non-oscillation thread cutting, the set threading amount is changed in a case of oscillation thread cutting. A setting rule will be described later.

The threading amount determination unit 20 determines a threading amount used during actual machining based on a set threading amount included in the machining conditions and the setting rule that the threading amount rule setting unit 13 sets.

The machining control unit 21 generates an operation command based on the threading amount that the threading amount determination unit 20 has determined to perform operation control based on the operation command. Under the operation control, the motor 3, for example, is driven, the workpiece and the cutting tool move, and thread cutting s executed.

The storage unit 14 stores various types of information for controlling and performing machining with the machine tool. In the present embodiment, the storage unit 14 stores the machining conditions and the oscillation conditions. Machining conditions and oscillation conditions are, for example, those that the operator has inputted in a machining program or those specified as parameters for a machine tool. Note that the storage unit 14 may not be provided in but may be disposed outside the control device 1.

The input unit 15 inputs, for example, information related to machining in accordance with an input operation of the operator with respect to an input means (not shown) such as a keyboard or a touch panel. The information related to machining, which is inputted through the input unit 15, is, for example, stored in the storage unit 14 or inputted to each component of the control device 1.

The display unit 16 displays various types of information related to the machine tool, the control device 1, and machining. The display unit 16 includes, for example, a display.

An entire configuration of the control device 1 has been described above. Next, a machining program specifying non-oscillation thread cutting will now be described herein.

FIG. 2 is a view illustrating an example of a machining program when no oscillation cutting is performed, in the first embodiment. The operator, for example, sets the machining program illustrated in FIG. 2.

In FIG. 2, “G76” represents a command of one block in the machining program, and a code for generating a movement block in thread cutting that is performed a plurality of times. Also, “Q” represents a code indicating a threading amount for a first time, “P” represents a code indicating a thread ridge height, and “R” represents a code indicating a thread ridge angle. As thread cutting conditions (a thread lead, a thread ridge angle, and a set threading amount), “G76 X9.0 Z10.0 F2.0” and “Q10.0 R60.0” in the machining program are acquired. In this example, a threading amount X for thread cutting for the first time=10.0 mm and a threading amount X for thread cutting for a second time=9.0 mm are acquired as set threading amounts.

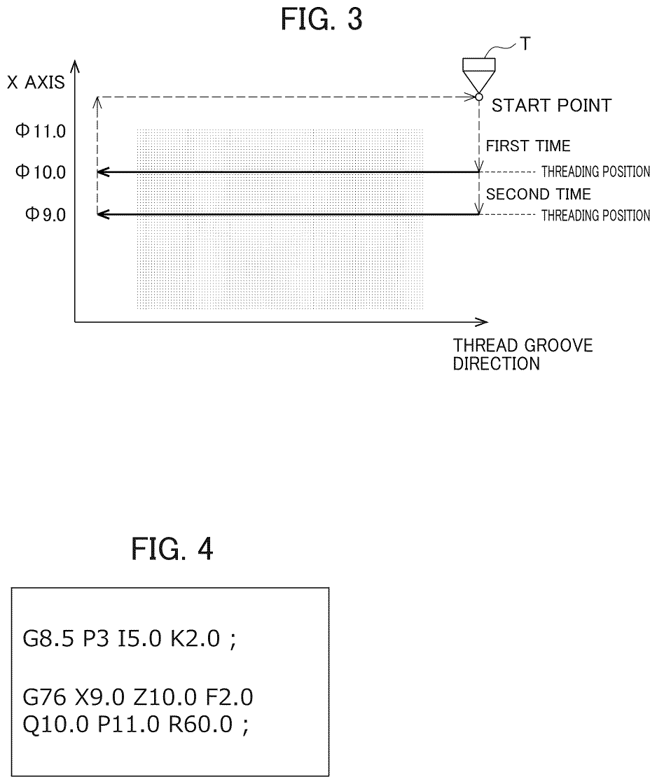

FIG. 3 is a graph illustrating a positional relationship between a workpiece and a cutting tool T when no oscillation cutting is performed, in the first embodiment. When the machining program illustrated in FIG. 2 is executed, an operation command as indicated in the graph illustrated in FIG. 3 is generated. In this example, since no oscillation mode is turned on, non-oscillation thread cutting is executed twice where the threading amount X=10.0 mm and the threading amount X=9.0 mm (set threading amounts) are regarded as threading amounts.

Next, a machining program specifying oscillation thread cutting will now be described herein. FIG. 4 is a view illustrating an example of a machining program when oscillation cutting is performed, in the first embodiment. The operator, for example, sets the machining program illustrated in FIG. 4.

In the machining program illustrated in FIG. 4, “G8.5 P3 I5.0 K2.0” is described, in addition to those described in the machining program illustrated in FIG. 2. In the machining program, “G8.5 P3” indicates that a mode for performing threading oscillation is turned ON. Furthermore, “I5.0 K2.0” subsequent to “G8.5 P3” indicates oscillation conditions including an oscillation frequency and an oscillation amplitude, for example. In this example, an oscillation frequency of 5.0 [Hz] and an oscillation amplitude of 2.0 [mm] serve as the oscillation conditions.

In the first embodiment, when the machining conditions indicate that oscillation is to be performed, similar or identical to the machining program illustrated in FIG. 4, processing for newly setting a threading amount based on a setting rule that is set beforehand is executed. Setting rules are set beforehand in the control device 1 based on priority. A first setting rule and a second setting rule, which are different from each other in priority, will now be described herein.

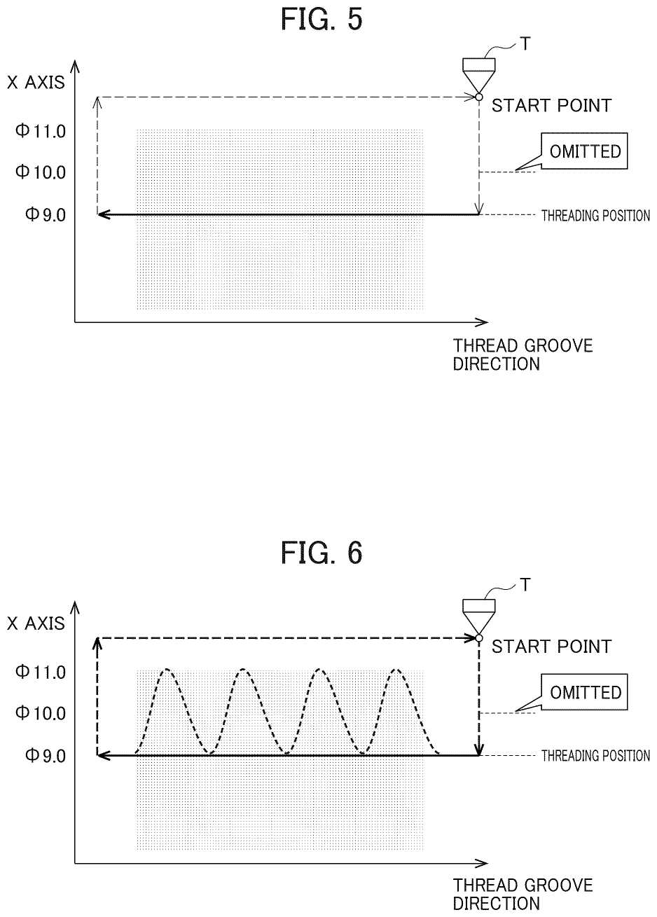

The first setting rule will now be described herein with reference to FIGS. 5 and 6. FIG. 5 is a graph illustrating a positional relationship between the workpiece and the cutting tool T when the first setting rule is applied and a threading amount is changed. FIG. 6 is a graph illustrating a positional relationship between the workpiece and the cutting tool T during oscillation cutting when the first setting rule is applied.

The first setting rule represents a rule for prioritizing a reduction in a number of times of machining for shortening a cycle time, and for specifying, in a case of oscillation thread cutting, a threading amount for achieving a number of times of executions smaller than that in normal thread cutting.

In the example illustrated in FIG. 5, set threading positions indicating that a thread ridge position is 11.0 mm, a set threading position is 10.0 mm, and a threading position serving as a finishing position is 9.0 mm are acquired from a machining program.

Next, the threading amount determination unit 20 acquires a number of threading positions to be canceled from the setting rule that the threading amount rule setting unit 13 has set and a canceling method. In this example, it is assumed that a rule for canceling even-number-th threading. The threading amount determination unit 20 cancels threading positions for the even-number-th times counted from the thread ridge position in accordance with the setting rule. That is, among the set threading amounts in thread cutting to be executed twice in a case of no oscillation, the threading amount X=10 mm for the first time is omitted. Then, as illustrated in FIG. 6, oscillation thread cutting and non-oscillation thread cutting are to be executed based on only the threading amount X=9.0 mm for the second time.

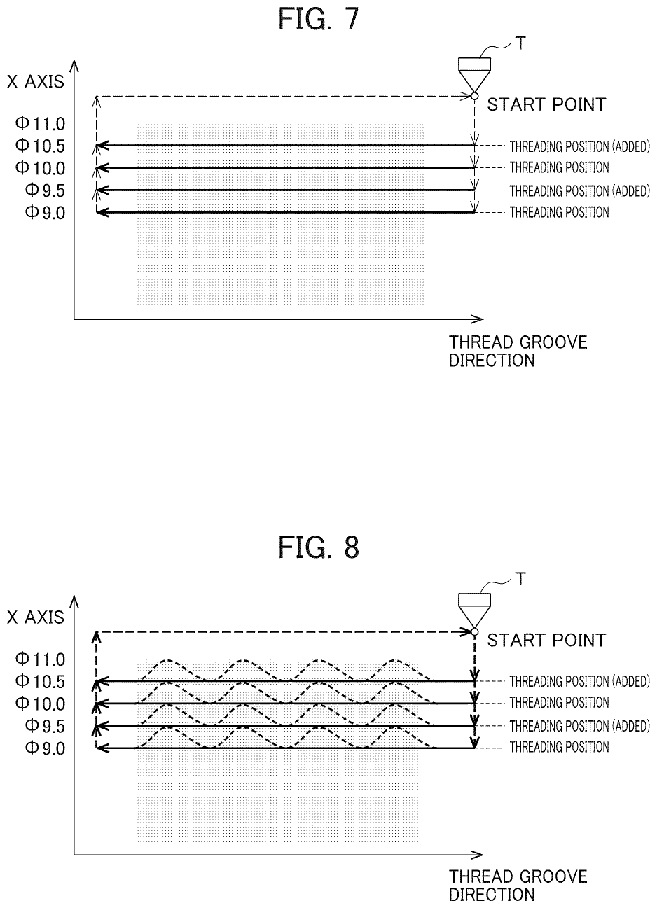

The second setting rule will now be described herein with reference to FIGS. 7 and 8. FIG. 7 is a graph illustrating a positional relationship between the workpiece and the cutting tool T when the second setting rule is applied and a threading amount is changed. FIG. 8 is a graph illustrating a positional relationship between the workpiece and the cutting tool T during oscillation cutting when the second setting rule is applied.

The second setting rule represents a rule for prioritizing a reduction in burdens on the workpiece and the cutting tool T per one machining, and for specifying, in a case of oscillation thread cutting, a threading amount for achieving a number of times of executions greater than that in normal thread cutting.

Even in the example illustrated in FIG. 7, set threading positions indicating that a thread ridge position is 11.0 mm, a set threading position is 10.0 mm, and a threading position serving as a finishing position is 9.0 mm are acquired from a machining program.

Next, the threading amount determination unit 20 acquires a number of threading positions to be added from the setting rule that the threading amount rule setting unit 13 has set and a method for adding the threading positions. In this example, it is a setting rule for adding the threading positions at intermediate positions between the acquired threading positions. A threading amount X=10.5 mm is added between the thread ridge position of 11.0 mm and the threading amount X=10 mm, and a threading amount X=9.5 mm is added between the threading amount X=10 mm and the threading amount of 9.0 mm. That is, a total of four threading amounts, that is, the added threading amount X=10.5 mm for the first time, the threading amount X=10.0 mm for the second time, the added threading amount X=9.5 mm for a third time, and the threading amount X=9.0 mm for a fourth time, is specified. As described above, when oscillation thread cutting is to be performed, threading amounts for two times are further added to the set threading amounts for thread cutting to be executed twice in a case of no oscillation. Then, as illustrated in FIG. 8, oscillation thread cutting and non-oscillation thread cutting are to be executed for each of the threading amount X=10.5 mm, the threading amount X=10.0 mm, the threading amount X=9.5 mm, and the threading amount X=9.0 mm.

Note that, although, under the second setting rule, the threading amounts have been added based on the positions of the set threading amounts, the present disclosure is not limited to this style, and a threading amount may be set in accordance with a predetermined index. For example, instead of a position of a set threading amount, a threading position may be added to allow a maximum amount of cutting in each threading to be constant. It is possible to calculate a threading amount from a maximum amount of cutting with a known calculation method. In this example, oscillation thread cutting and non-oscillation thread cutting are to be executed for each of an added threading amount X=10.4 mm for the first time, the threading amount X=10.0 mm for the second time, an added threading amount X=9.4 mm for the third time, and the threading amount X=9.0 mm for the fourth time.

In addition, under the second setting rule, a threading position may be added for each threading amount in accordance with a predetermined maximum amount of cutting, which is set for each threading. In this example, instead of the predetermined threading amount, a predetermined maximum area of cutting is set beforehand in the control device 1. The maximum area of cutting referred herein represents an area of cutting when a threading position during oscillation has reached a deepest position. Under the setting rule, a known calculation method is used to calculate a predetermined threading amount for achieving a maximum area of cutting, and adds a threading position between threading positions.

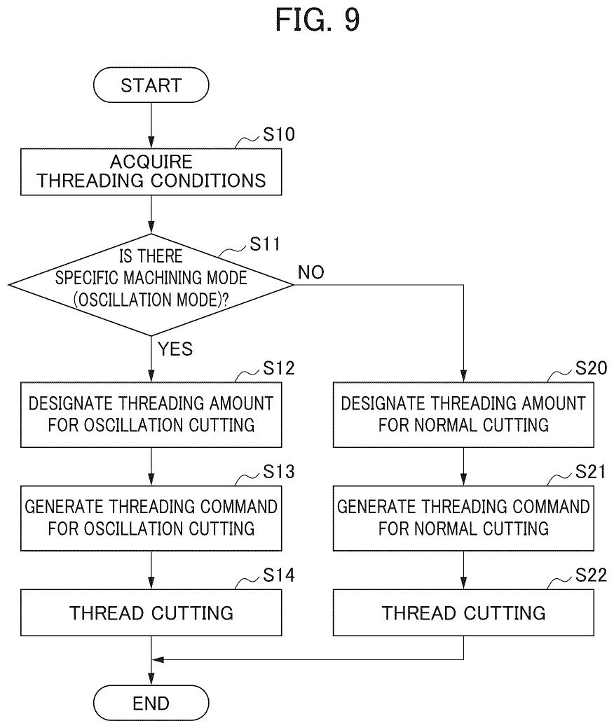

Next, a flow of processing for generating a threading command will now be described herein with reference to FIG. 9. FIG. 9 is a flowchart illustrating an example of processing for generating a threading command by the control device for the machine tool.

As illustrated in FIG. 9, as the operator instructs start of machining, the machining condition acquisition unit 11 acquires threading conditions for performing thread cutting (Step S10). The threading conditions include, for example, machining conditions including a threading amount and oscillation conditions as described above. Furthermore, the threading conditions are acquired, as described above, from a machining program stored in the storage unit 14 or parameters set for the machine tool, for example.

Next, in Step S11, the machining determination unit 12 determines whether or not there is a specific machining mode (oscillation thread cutting) from the machining conditions (Step S11). In the first embodiment, the machining determination unit 12 causes the processing to proceed to Step S12 in a case of oscillation thread cutting (Step S11; Yes), and causes the processing to proceed to Step S20 in a case of non-oscillation thread cutting (Step S11; No).

A case when oscillation thread cutting is determined will now first be described herein. In Step S12, the threading amount rule setting unit 13 sets a setting rule based on a result of the determination by the machining determination unit 12, and the threading amount determination unit 20 newly specifies a threading amount for oscillation thread cutting based on a set threading amount and the setting rule (see FIGS. 5 and 7).

After Step S12, the machining control unit 21 generates a threading command for oscillation cutting based on the threading amount determined by the threading amount determination unit 20 (Step S13), and oscillation thread cutting is executed (Step S14).

Next, a case when non-oscillation thread cutting is determined will now be described herein. In Step S20, the threading amount rule setting unit 13 sets a setting rule based on a result of the determination by the machining determination unit 12, and the threading amount determination unit 20 specifies a set threading amount as a threading amount for normal non-oscillation cutting.

Next, the machining control unit 21 generates a threading command for normal cutting for executing non-oscillation thread cutting based on the threading amount determined by the threading amount determination unit 20 (Step S21), and normal non-oscillation thread cutting is executed (Step S22).

With the control device 1 for the machine tool, according to the first embodiment, which performs thread cutting on the workpiece using the cutting tool T, as described above, effects described below are achieved.

The control device 1 for the machine tool, according to the present embodiment, includes: the machining condition acquisition unit 11 that acquires machining conditions for thread cutting; the machining determination unit 12 that determines a type of machining from the machining conditions; the threading amount rule setting unit 13 that, based on a result of the determination by the machining determination unit 12, determines a setting rule that is a method for setting a threading amount for the thread cutting; and the threading amount determination unit 20 that, based on the machining conditions and the setting rule, determines a threading amount used during machining. Thereby, a threading amount in which priority for the operator is reflected is automatically set, and thread cutting appropriate for an actual situation is executed. When a cycle time is desired to be shortened, for example, setting a setting rule for adjusting a threading amount to reduce a number of times of machining makes it possible to achieve a shortened cycle time, since it is possible to cool machining heat on the cutting tool T when air-cutting is executed (the examples illustrated in FIGS. 5 and 6). Furthermore, when a burden on the cutting tool T in one machining is desired to be mitigated, setting a setting rule for adjusting a threading amount to increase a number of times of machining to reduce a threading amount for one time makes it possible to reduce a burden on the cutting tool T (the examples illustrated in FIGS. 7 and 8).

Furthermore, the machining determination unit 12 according to the present embodiment determines, from the machining conditions, machining in which oscillation cutting is to be performed or machining in which oscillation cutting is not to be performed, and the threading amount rule setting unit 13 determines a setting rule in accordance with whether or not oscillation is to be performed. Thereby, oscillation cutting that has a large influence on cycle time and the cutting tool T is identified, making it possible to execute thread cutting based on a threading amount appropriate for oscillation thread cutting.

Furthermore, the machining condition acquisition unit 11 according to the present embodiment acquires a set threading amount that is set beforehand, and the threading amount determination unit 20, based on the set threading amount and the setting rule, determines a threading amount used during machining. Thereby, even when a threading amount is set beforehand, automatic adjustment to a threading amount in which priority for the operator is reflected is performed, easily achieving highly productive and highly safe thread cutting.

Furthermore, the threading amount rule setting unit 13 according to the present embodiment sets, in a case where oscillation is determined to be performed, a setting rule for adding a threading position between a plurality of threading positions that the machining condition acquisition unit 11 acquires from the machining conditions, and the threading amount determination unit 20 sets, for allowing an interval of threading or a maximum amount of cutting in threading to be constant, based on the setting rule, a set threading amount of a threading amount in accordance with the maximum amount of cutting. Thereby, an operation command for prioritizing a reduction in a burden on the workpiece or the cutting tool T per one machining is automatically set, easily achieving machining satisfying a request of the operator.

Furthermore, the threading amount rule setting unit 13 according to the present embodiment determines a setting rule for canceling at least one of a plurality of threading positions that the set threading amount indicates. Thereby, an operation command for prioritizing a reduction in a number of times of machining for shortening a cycle time is automatically set, easily achieving machining satisfying a request of the operator.

Although the control device 1 for the machine tool, according to the first embodiment, has been described above, the present disclosure is not limited to the configuration of the embodiment described above. For example, a setting rule is not limited in contents to those described in the embodiment described above, and it is possible to appropriately change a method for setting a threading amount in accordance with each of various types of conditions. Embodiments when there is a difference from those in the embodiment described above will now be described herein.

### Second Embodiment

Next, a control device 1 according to a second embodiment will now be described herein. Note that a basic configuration of the control device 1 according to the second embodiment is common to the configuration illustrated in FIG. 1.

In the second embodiment, a threading amount per one time is set beforehand in the control device 1, instead of a machining program. For example, the threading amount is stored in the storage unit 14 as a parameter that is set for the control device 1 for the machine tool. In the present embodiment, a predetermined threading amount is set to 0.7 mm.

The machining condition acquisition unit 11 acquires information indicating a threading position from machining conditions. For example, the machining condition acquisition unit 11 acquires a thread ridge position of 11.0 mm and a finishing position (a target position) of 9.0 mm as information indicating threading positions.

Even in the second embodiment, the control device 1 executes, when the machining conditions indicate that oscillation is to be performed, processing for newly setting a threading amount based on a setting rule that is set beforehand.

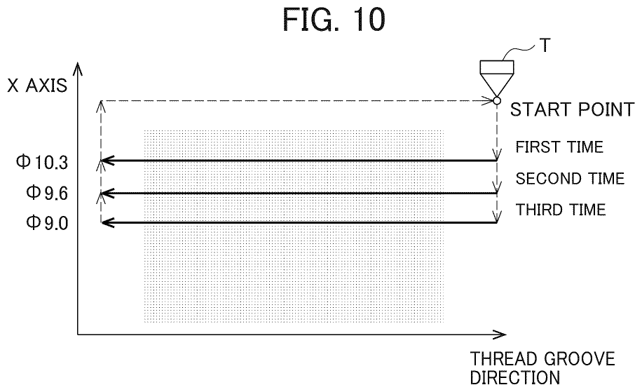

A setting rule according to the second embodiment will now be described herein with reference to FIG. 10. FIG. 10 is a graph illustrating a positional relationship between the workpiece and the cutting tool T when a setting rule is applied and a threading amount is set, in the second embodiment. Under the setting rule, a threading amount is specified based on a thread ridge position representing a threading position acquired from machining conditions, a finishing position, and a predetermined threading amount.

In the example illustrated in FIG. 10, a threading amount for oscillation cutting is specified by subtracting the predetermined threading amount from those ranging from the thread ridge position of 11.0 mm to the finishing position (the target position) of 9.0 mm. In this example, 10.3 mm that is acquired by subtracting the predetermined threading amount of 0.7 from the thread ridge position of 11.0 mm is specified as a threading amount for thread cutting for the first time. Next, 9.6 mm acquired by subtracting the predetermined threading amount of 0.7 from 10.3 mm is specified as a threading amount for thread cutting for the second time. Since subtracting the predetermined threading amount of 0.7 from 9.6 mm results in 8.9, exceeding the finishing position (the target position) of 9.0 mm, the finishing position of 9.0 mm is specified as a threading amount for thread cutting for the third time. Then, oscillation thread cutting and non-oscillation thread cutting are to be executed for each of the specified threading amount of 10.3 mm, the specified threading amount of 9.6 mm, and the specified threading amount of 9.0 mm.

Note that, in the second embodiment, a threading amount has been specified based on a predetermined threading amount, the present disclosure is not limited to this style, and a threading amount may be determined in accordance with a predetermined index. For example, such a means as described below may be used. Instead of the predetermined threading amount, a predetermined maximum area of cutting is set beforehand in the control device 1. The maximum area of cutting referred herein represents an area of cutting when a threading position during oscillation has reached a deepest position. Under a setting rule, a known calculation method is used to calculate a predetermined threading amount for achieving a maximum area of cutting. A method for specifying a threading amount for oscillation cutting is similar or identical to that in the processing described above. Even in this example, oscillation thread cutting and non-oscillation thread cutting are to be executed for each of the specified threading amount of 10.3 mm, the specified threading amount of 9.6 mm, and the specified threading amount of 9.0 mm.

With the control device 1 for the machine tool, according to the second embodiment, which performs thread cutting on the workpiece using the cutting tool T, as described above, effects described below are achieved.

In the present embodiment, for machining that the machining determination unit 12 determines as specific machining, a setting rule for setting, for each threading amount in accordance with a predetermined threading amount of a predetermined maximum area of cutting, the threading amount is determined. Thereby, even when a predetermined threading amount or a predetermined maximum area of cutting has been set, an operation command satisfying a request of the operator is automatically set.

### Third Embodiment

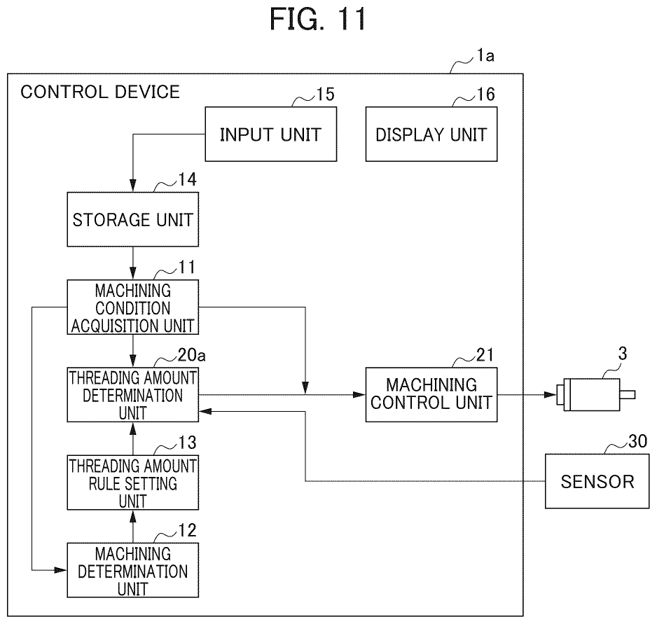

Next, a control device 1a according to a third embodiment will now be described herein with reference to FIG. 11. FIG. 11 is a functional block diagram of the control device 1a for the machine tool, according to the third embodiment. In the third embodiment, a different point from the embodiments described above is that the control device 1a includes a sensor 30 that measures a temperature of the cutting tool T for threading or of a drive motor, for example, and other components are common to those in the embodiments described above.

In the control device 1a according to the third embodiment, a setting rule similar or identical to the first setting rule according to the first embodiment is set. Under the setting rule, the sensor 30 detects a present machining state (a present temperature) at a point in time when the cutting tool T is positioned at a start point. In a threading amount determination unit 20a according to the third embodiment, when a result of the detection by the sensor 30 indicates that there is not a margin in the machining state, such as the temperature is fully low, processing for canceling a threading position for machining for a next time and later is performed. For example, when the temperature is lower than a specified value, processing for canceling one threading position is executed. As described above, such a configuration may be applied that a setting rule be changed in accordance with a machining state.

### Fourth Embodiment

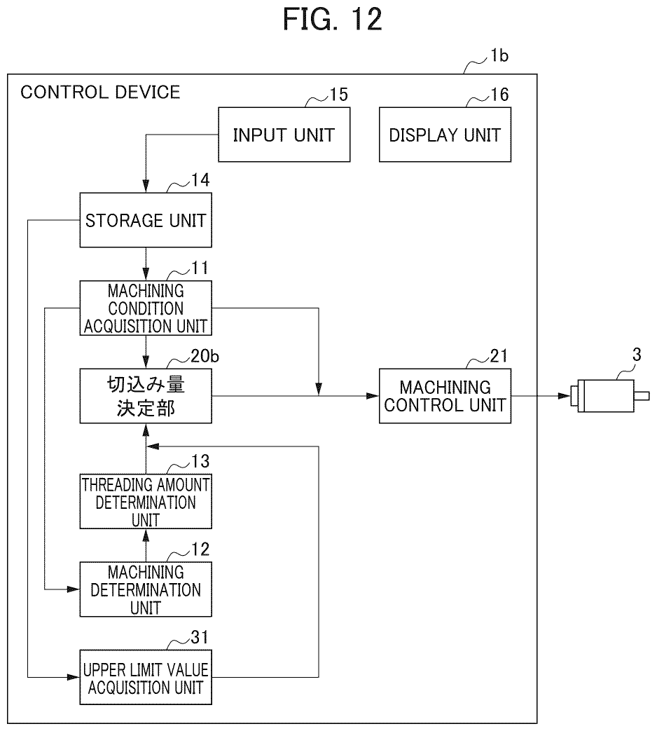

Next, a control device 1b according to a fourth embodiment will now be described herein with reference to FIG. 12. FIG. 12 is a functional block diagram of the control device 1b for the machine tool, according to the fourth embodiment. In the fourth embodiment, a different point from the embodiments described above is that the control device 1b includes an upper limit value acquisition unit 31, and other components are common to those in the embodiments described above.

In the fourth embodiment, the upper limit value acquisition unit 31 acquires an upper limit value related to cutting. The upper limit value may be, for example, an upper limit value of a threading amount, an upper limit value of an amount of cutting, or an allowable burden during cutting. The upper limit value is set by taking into consideration an instantaneous maximum value when oscillation is performed. The upper limit value is stored in the storage unit 14 as a parameter for a machining program or the control device 1 for the machine tool. Note that the upper limit value may be stored in an external storage device.

A threading amount determination unit 20b according to the fourth embodiment determines a threading amount for actual thread cutting, in which the upper limit value that the upper limit value acquisition unit 31 has acquired is reflected. That is, when the upper limit value of one of the threading amount, the amount of cutting, and the allowable burden during cutting has been exceeded, as a result by following the setting rule, processing for performing correction to allow the threading amount to be equal to the upper limit value or to be smaller than the upper limit value is executed. Otherwise, no setting rule for setting a threading amount in accordance with a predetermined threading amount or a predetermined maximum area of cutting may be provided, and a setting rule for setting a threading amount for allowing machining to be performed with an upper limit value of one of a threading amount, an amount of cutting, and an allowable burden during cutting per threading may be provided.

With the control device 1b for the machine tool, according to the fourth embodiment, which performs thread cutting on the workpiece using the cutting tool T, as described above, effects described below are achieved.

The control device 1b according to the present embodiment further includes the upper limit value acquisition unit 31 that acquires an upper limit value related to cutting, and the threading amount determination unit 20b determines a threading amount in which the upper limit value is reflected in addition to the machining conditions and the setting rule. Thereby, even when a threading amount changes, similar or identical to that in oscillation thread cutting, an upper limit value is automatically reflected in an operation command, making it possible to achieve highly safe and highly secure thread cutting without requiring separate specification by an operator. Otherwise, it is possible to perform machining with an upper limit value per threading, making it possible to achieve highly efficient thread cutting.

Note that, although, in the embodiments and the modification examples described above, the examples where, as a format for a machining program, a code for generating a movement block in thread cutting to be repeated a plurality of times with a command of one block in a machining program, such as “G76”, is used have been introduced, the present technique is also applicable to, for example, a case where the operation illustrated in FIG. 3 is programed by using a code “G92” for generating operation in one cycle (a start point, positioning on the X axis, thread cutting, and returning to the start point) of thread cutting twice and a case where such operation that a code indicating positioning “G00” and a code indicating threading “G32” are combined with each other and one cycle of thread cutting is executed twice is programed. In this case, a threading amount used during machining may be determined in accordance with a set threading amount acquired from a machining program, or, similar or identical to the second embodiment, a thread ridge position and a finishing position may be acquired to determine a threading amount used during machining.

In addition, although, in the embodiments and the modification examples described above, the example where the specific machining that the machining determination unit 12 determines is oscillation thread cutting or non-oscillation thread cutting has been described, the present disclosure is not limited to the configuration. For example, such a configuration may be adopted in which ultrasonic machining is identified as a specific function. Furthermore, such a configuration may be adopted in which machining using a specific tool that is superior in wear resistance is identified, and, in a case of the machining, a setting rule under which wear resistance is taken into consideration is applied.

In addition, although, in the embodiments described above, a command for alternately repeating oscillation thread cutting and non-oscillation thread cutting is automatically generated, the present disclosure is not limited to the embodiments. For example, such a configuration may be applied that, after oscillation thread cutting is executed a plurality of times, non-oscillation thread cutting is executed at least once. In this case, for performing air-cutting processing, it is preferable that machining control be performed to adjust oscillation conditions to allow tops and bottoms of continuous oscillation thread cutting to overlap with each other. For example, the machining control unit 21 performs processing for shifting a phase of an oscillation condition 180 degrees, making it possible to allow tops and bottoms of continuous oscillation thread cutting to overlap with each other.

Although the present disclosure has been described in detail, the present disclosure is not limited to each of the embodiments described above. It is possible to variously make additions, replacements, modifications, and partial deletions, for example, in the embodiments without departing from the gist of the present disclosure or without departing from the scope of the present disclosure, which is derived from the contents described in Claims and their equivalents. Furthermore, it is possible to implement the embodiments in a combined manner. For example, in the embodiments described above, the order of operations and the order of steps in the processing are indicated as mere examples, and the present disclosure is not limited to the embodiments. Furthermore, the same applies to cases where a numerical value or a numerical expression is used to describe the embodiments described above.

Regarding the embodiments and the modification examples described above, additional remarks described below are further disclosed.

### Additional Remark 1

The control device (1, 1a, 1b) for the machine tool that performs thread cutting on a workpiece using the cutting tool (T), including: a machining condition acquisition unit (11) that acquires machining conditions for thread cutting; a machining determination unit (12) that determines a type of machining from the machining conditions; a threading amount rule setting unit (13) that, based on a result of the determination by the machining determination unit, determines a setting rule that is a method for setting a threading amount for the thread cutting; and a threading amount determination unit (20, 20a, 20b) that, based on the machining conditions and the setting rule, determines a threading amount used during machining.

### Additional Remark 2

In the control device (1, 1a, 1b) for the machine tool, described above, the machining determination unit (12) determines, from the machining conditions, machining in which oscillation cutting is to be performed or machining in which oscillation cutting is not to be performed, and the threading amount rule setting unit (13) determines the setting rule in accordance with whether or not oscillation is to be performed.

### Additional Remark 3

In the control device (1, 1a, 1b) for the machine tool, described above, the machining condition acquisition unit (11) acquires a set threading amount that is set beforehand, and the threading amount determination unit (20, 20a, 20b), based on the set threading amount and the setting rule, determines the threading amount used during machining.

### Additional Remark 4

In the control device (1, 1a, 1b) for the machine tool, described above, the threading amount rule setting unit (13) sets, in a case where oscillation is determined to be performed, a setting rule for adding a threading position between a plurality of threading positions that the machining condition acquisition unit (11) acquires from the machining conditions, and the threading amount determination unit (20, 20a, 20b) sets, for allowing a predetermined index to be constant, based on the setting rule, a threading amount in accordance with the predetermined index.

### Additional Remark 5

In the control device (1, 1a, 1b) for the machine tool, described above, the threading amount rule setting unit (13) determines a setting rule for canceling at least one of a plurality of threading positions that the set threading amount indicates.

### Additional Remark 6

In the control device (1, 1a, 1b) for the machine tool, described above, for machining that the machining determination unit (12) determines as specific machining, a setting rule for setting, for each threading amount in accordance with a predetermined index, the threading amount is determined.

### Additional Remark 7

In the control device (1b) for the machine tool, described above, an upper limit value acquisition unit (31) that acquires an upper limit value related to cutting is further included, in which the threading amount determination unit (20b) determines a threading amount in which the upper limit value is reflected in addition to the machining conditions and the setting rule.

### EXPLANATION OF REFERENCE NUMERALS

1, 1a, 1b Control device for machine tool
11 Machining condition acquisition unit
12 Machining determination unit
13 Threading amount rule setting unit
20, 20a, 20b Threading amount determination unit
31 Upper limit value acquisition unit
T Cutting tool

1. A control device for a machine tool that performs thread cutting on a workpiece using a cutting tool, the control device for the machine tool comprising:
a machining condition acquisition unit that acquires machining conditions for thread cutting;
a machining determination unit that determines a type of machining from the machining conditions;
a threading amount rule setting unit that, based on a result of the determination by the machining determination unit, determines a setting rule that is a method for setting a threading amount for the thread cutting; and
a threading amount determination unit that, based on the machining conditions and the setting rule, determines a threading amount used during machining.

2. The control device for the machine tool, according to claim 1, wherein
the machining determination unit determines, from the machining conditions, machining in which oscillation cutting is to be performed or machining in which oscillation cutting is not to be performed, and
the threading amount rule setting unit determines the setting rule in accordance with whether or not oscillation is to be performed.

3. The control device for the machine tool, according to claim 1, wherein
the machining condition acquisition unit acquires a set threading amount that is set beforehand, and
the threading amount determination unit, based on the set threading amount and the setting rule, determines the threading amount used during machining.

4. The control device for the machine tool, according to claim 3, wherein
the threading amount rule setting unit sets, in a case where oscillation is determined to be performed, a setting rule for adding a threading position between a plurality of threading positions that the machining condition acquisition unit acquires from the machining conditions, and
the threading amount determination unit sets, for allowing a predetermined index to be constant, based on the setting rule, a threading amount in accordance with the predetermined index.

5. The control device for the machine tool, according to claim 3, wherein the threading amount rule setting unit determines a setting rule for canceling at least one of a plurality of threading positions that the set threading amount indicates.

6. The control device for the machine tool, according to claim 1, wherein, for machining that the machining determination unit determines as specific machining, a setting rule for setting, for each threading amount in accordance with a predetermined index, the threading amount is determined.

7. The control device for the machine tool, according to claim 1,
further comprising an upper limit value acquisition unit that acquires an upper limit value related to cutting,
wherein the threading amount determination unit determines a threading amount in which the upper limit value is reflected in addition to the machining conditions and the setting rule.
